(19) United States
(12) Patent Application Publication
(10) Pub. No.: US 2023/0201764 A1
(43) Pub. Date: Jun. 29, 2023

(54) DEVICE AND METHOD BASED ON ELECTRICALLY-DRIVEN CHEMICAL CARBON PUMP COMBINED CYCLE FOR DILUTED CARBON SOURCE

(71) Applicant: Tianjin University, Tianjin (CN)

(72) Inventors: Shuai DENG, Tianjin (CN); Peng SUN, Tianjin (CN); Yaowei HUANG, Tianjin (CN)

(21) Appl. No.: 18/147,176

(22) Filed: Dec. 28, 2022

(30) Foreign Application Priority Data
Dec. 29, 2021 (CN) 202111641427.6

(51) Int. Cl. B01D 53/32; B01D 53/62; B01D 53/96

(52) U.S. Cl. CPC B01D 53/326; B01D 53/62; B01D 53/965; B01D 2257/504; B01D 2258/06; B01D 2251/306; B01D 2251/606; B01D 2256/22

(57) ABSTRACT

The present disclosure relates to a device and method based on an electrically-driven chemical carbon pump combined cycle for a diluted carbon source. The device includes: an electrolytic cell and a cell structure. The electrolytic cell includes a cathode reaction chamber, a CO₂ desorption chamber, a CO₂ absorption chamber, and an anode reaction chamber that are connected in sequence. The CO₂ desorption chamber and the CO₂ absorption chamber are communicated through a bipolar membrane (BPM). The cell structure includes: a negative electrode, a positive electrode, a positive region, and a negative region. The negative electrode is arranged in the negative region, and the positive electrode is arranged in the positive region. The negative electrode is connected with the cathode reaction chamber, and the positive electrode is connected with the anode reaction chamber. A liquid outlet of the negative region is communicated with a liquid inlet of the cathode reaction chamber. A liquid inlet of the negative region is communicated with a liquid outlet of the cathode reaction chamber. A liquid outlet of the positive region is communicated with a liquid inlet of the anode reaction chamber.

### TECHNICAL FIELD

The present disclosure relates to the technical field of carbon capture, and in particular, to a device and method based on an electrically-driven chemical carbon pump combined cycle for a diluted carbon source.

### BACKGROUND

In recent years, the massive burning of fossil fuels has increased the concentration of CO₂ in the atmosphere, which leads to the increasingly serious greenhouse effect. With the increasing demand for energy, fossil fuels will continue to be the main source of energy in the coming decades. Traditional carbon capture modes, such as post-combustion capture from large point sources, can slow down the increase of CO₂ concentration in the atmosphere. However, direct capture of CO₂ in the air, as a representative of negative carbon technology, can “intervene” the CO₂ concentration in the atmosphere more directly. The existing air carbon capture technologies include solution absorption, solid adsorption, and electrodialysis, but there is no electrodialysis with bipolar membranes (EDBM) for air carbon capture. Therefore, it is very necessary to use the EDBM for air carbon capture.

### SUMMARY

An objective of the present disclosure is to provide a device and method based on an electrically-driven chemical carbon pump combined cycle for a diluted carbon source, so as to realize carbon capture using EDBM, which can improve the carbon capture rate and capture purity.

To achieve the above objective, the present disclosure provides the following solution:

A device based on an electrically-driven chemical carbon pump combined cycle for a diluted carbon source includes:

an electrolytic cell and a cell structure, where the electrolytic cell includes a cathode reaction chamber, a CO₂ desorption chamber, a CO₂ absorption chamber, and an anode reaction chamber that are connected in sequence; and the CO₂ desorption chamber and the CO₂ absorption chamber are communicated through a bipolar membrane (BPM);

the cell structure includes: a negative electrode, a positive electrode, a positive region, and a negative region; and the negative electrode is arranged in the negative region, and the positive electrode is arranged in the positive region; and

the negative electrode is connected with the cathode reaction chamber; the positive electrode is connected with the anode reaction chamber, and a liquid outlet of the negative region is communicated with a liquid inlet of the cathode reaction chamber; a liquid inlet of the negative region is communicated with a liquid outlet of the cathode reaction chamber; a liquid outlet of the positive region is communicated with a liquid inlet of the anode reaction chamber; and a liquid inlet of the positive region is communicated with a liquid outlet of the anode reaction chamber.

Optionally, a K₄[Fe(CN)₆] solution is introduced into the negative region and a K₃[Fe(CN)₆] solution is introduced into the positive region.

Optionally, the device based on an electrically-driven chemical carbon pump combined cycle for a diluted carbon source further includes: a K₄[Fe(CN)₆] solution storage tank. A liquid inlet of the K₄[Fe(CN)₆] solution storage tank is communicated with a liquid outlet of the cathode reaction chamber, and a liquid outlet of the K₄[Fe(CN)₆] solution storage tank is communicated with a liquid inlet of the negative region.

Optionally, the device based on an electrically-driven chemical carbon pump combined cycle for a diluted carbon source further includes: a K₃[Fe(CN)₆] solution storage tank. A liquid inlet of the K₃[Fe(CN)₆] solution storage tank is communicated with a liquid outlet of the anode reaction chamber, and a liquid outlet of the K₃[Fe(CN)₆] solution storage tank is communicated with a liquid inlet of the positive region.

Optionally, the cathode reaction chamber is communicated with the CO₂ desorption chamber through a cation exchange membrane (CEM), and the CO₂ absorption chamber is communicated with the anode reaction chamber through a CEM.

Optionally, the positive region is communicated with the negative region through a CEM.

Optionally, a solution in the CO₂ desorption chamber and the CO₂ absorption chamber is a KHCO₃ solution.

A method based on an electrically-driven chemical carbon pump combined cycle for a diluted carbon source is applied to the above device based on an electrically-driven chemical carbon pump combined cycle for a diluted carbon source and includes:

introducing a diluted carbon source containing CO₂ of a first concentration into the CO₂ absorption chamber, where the CO₂ of the first concentration reacts with OH⁻ from the BPM in the CO₂ absorption chamber to generate HCO₃⁻;

enabling the HCO₃⁻ to combine with K⁺ from the anode reaction chamber to generate a KHCO₃ solution; and

introducing the generated KHCO₃ solution into the CO₂ desorption chamber, where the generated KHCO₃ reacts with H⁺ from the BPM in the CO₂ desorption chamber to generate H₂O, K⁺, and CO₂ of a second concentration; and precipitating the CO₂ of the second concentration and capturing the CO₂ of the second concentration at an air outlet of the CO₂ desorption chamber, where the second concentration is greater than the first concentration.

According to specific examples provided by the present disclosure, the present disclosure discloses the following technical effects: the device based on an electrically-driven chemical carbon pump combined cycle for a diluted carbon source provided by the present disclosure includes: an electrolytic cell and a cell structure. The electrolytic cell includes a cathode reaction chamber, a CO₂ desorption chamber, a CO₂ absorption chamber, and an anode reaction chamber that are connected in sequence. The CO₂ desorption chamber and the CO₂ absorption chamber are communicated through a BPM. The cell structure includes: a negative electrode, a positive electrode, a positive region, and a negative region. The negative electrode is arranged in the negative region, and the positive electrode is arranged in the positive region. The negative electrode is connected with the cathode reaction chamber. The positive electrode is connected with the anode reaction chamber, and a liquid outlet of the negative region is communicated with a liquid inlet of the cathode reaction chamber. A liquid inlet of the negative region is communicated with a liquid outlet of the cathode reaction chamber. A liquid outlet of the positive region is communicated with a liquid inlet of the anode reaction chamber. A liquid inlet of the positive region is communicated with a liquid outlet of the anode reaction chamber. The present disclosure directly captures CO₂ in the diluted carbon source using EDBM, which can improve a carbon capture rate and capture purity.

### BRIEF DESCRIPTION OF THE DRAWINGS

To describe the technical solutions in the examples of the present disclosure or in the prior art more clearly, the accompanying drawings required for the examples are briefly described below. Apparently, the accompanying drawings in the following description show merely some examples of the present disclosure, and those of ordinary skill in the art may still derive other accompanying drawings from these accompanying drawings without creative efforts.

FIG. 1 is a structural diagram of a device based on an electrically-driven chemical carbon pump combined cycle for a diluted carbon source provided by an example of the present disclosure; and

FIG. 2 is a schematic diagram of a working process of the device based on an electrically-driven chemical carbon pump combined cycle for a diluted carbon source provided by an example of the present disclosure.

### REFERENCE NUMERALS

CEM-cation exchange membrane, and BPM-bipolar membrane.

### DETAILED DESCRIPTION OF THE EMBODIMENTS

The technical solutions of the examples of the present disclosure are clearly and completely described below with reference to the accompanying drawings. Apparently, the described examples are merely a part rather than all of the examples of the present disclosure. All other examples obtained by those of ordinary skill in the art based on the examples of the present disclosure without creative efforts shall fall within the protection scope of the present disclosure.

In order to make the above objectives, features and advantages of the present disclosure more obvious and understandable, the present disclosure is further described in detail in combination with the attached drawings and specific implementations.

The present disclosure designed a device based on an electrically-driven chemical carbon pump combined cycle for a diluted carbon source, which mainly captured CO₂ from the diluted carbon source. Compared with other carbon capture technologies, the present disclosure had a relatively high carbon capture rate and capture purity.

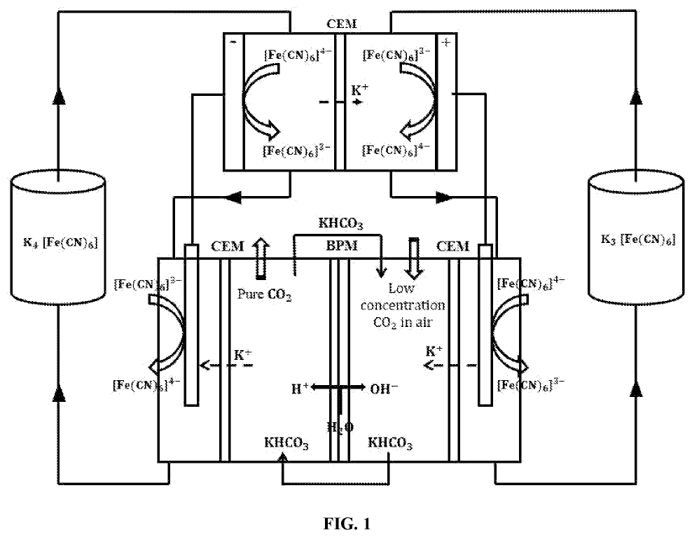

As shown in FIG. 1, a device based on an electrically-driven chemical carbon pump combined cycle for a diluted carbon source provided by an example of the present disclosure includes:

an electrolytic cell and a cell structure. The electrolytic cell includes a cathode reaction chamber, a CO₂ desorption chamber, a CO₂ absorption chamber, and an anode reaction chamber that are connected in sequence. The CO₂ desorption chamber and the CO₂ absorption chamber are communicated through a BPM. The cell structure includes: a negative electrode, a positive electrode, a positive region, and a negative region. The negative electrode is arranged in the negative region, and the positive electrode is arranged in the positive region. The negative electrode is connected with the cathode reaction chamber. The positive electrode is connected with the anode reaction chamber, and a liquid outlet of the negative region is communicated with a liquid inlet of the cathode reaction chamber. A liquid inlet of the negative region is communicated with a liquid outlet of the cathode reaction chamber. A liquid outlet of the positive region is communicated with a liquid inlet of the anode reaction chamber. A liquid inlet of the positive region is communicated with a liquid outlet of the anode reaction chamber. A solution introduced into the negative region is oxidized in the negative region to generate an oxidized solution, and the oxidized solution enters the cathode reaction chamber and is electrolyzed. A solution introduced into the positive region is reduced in the positive region to generate a reduced solution, and the reduced solution enters the anode reaction chamber and is electrolyzed.

In practical application, the BPM was generally a composite ion exchange membrane composed of a cation exchange layer, an anion exchange layer, and an intermediate reaction layer, such as a BP-1 BPM and a FBM BPM.

In practical applications, the negative electrode was connected with the cathode reaction chamber through a first electrode. The positive electrode was connected with the anode reaction chamber through a second electrode.

In practical applications, the first electrode and the second electrode were generally made of one or alloys or mixtures of two or more of Pt, Au, Pd, Ru, Ir, Rh, Re, Os, Cu, Ag, Fe, Co, Ni, Zn, and C.

In practical applications, a K₄[Fe(CN)₆] solution was introduced into the negative region and a K₃[Fe(CN)₆] solution was introduced into the positive region.

In practical applications, the device based on an electrically-driven chemical carbon pump combined cycle for a diluted carbon source further included: a K₄[Fe(CN)₆] solution storage tank. A liquid inlet of the K₄[Fe(CN)₆] solution storage tank was communicated with a liquid outlet of the cathode reaction chamber, and a liquid outlet of the K₄[Fe(CN)₆] solution storage tank was communicated with a liquid inlet of the negative region.

In practical applications, the device based on an electrically-driven chemical carbon pump combined cycle for a diluted carbon source further included: a K₃[Fe(CN)₆] solution storage tank. A liquid inlet of the K₃[Fe(CN)₆] solution storage tank was communicated with a liquid outlet of the anode reaction chamber, and a liquid outlet of the K₃[Fe(CN)₆] solution storage tank was communicated with a liquid inlet of the positive region.

In practical applications, the cathode reaction chamber was communicated with the CO₂ desorption chamber through a CEM, and the CO₂ absorption chamber was communicated with the anode reaction chamber through a CEM.

In practical applications, the positive region was communicated with the negative region through a CEM.

In practical applications, the CEM had selective permeability to cations, which was generally sulfonic acid type, with fixed groups and dissociable ions.

In practical applications, a solution in the CO₂ desorption chamber and the CO₂ absorption chamber was a KHCO₃ solution.

A method based on an electrically-driven chemical carbon pump combined cycle for a diluted carbon source was applied to the above device based on an electrically-driven chemical carbon pump combined cycle for a diluted carbon source and included the following steps.

A diluted carbon source containing CO₂ of a first concentration was introduced into the CO₂ absorption chamber. The CO₂ of the first concentration reacted with OH⁻ from the BPM in the CO₂ absorption chamber to generate HCO₃⁻.

The HCO₃⁻ combined with K⁺ from the anode reaction chamber to generate a KHCO₃ solution.

The generated KHCO₃ solution was introduced into the CO₂ desorption chamber. The generated KHCO₃ reacted with H⁺ from the BPM in the CO₂ desorption chamber to generate H₂O, K⁺, and CO₂ of a second concentration. The CO₂ of the second concentration was precipitated and captured at an air outlet of the CO₂ desorption chamber. The second concentration was greater than the first concentration.

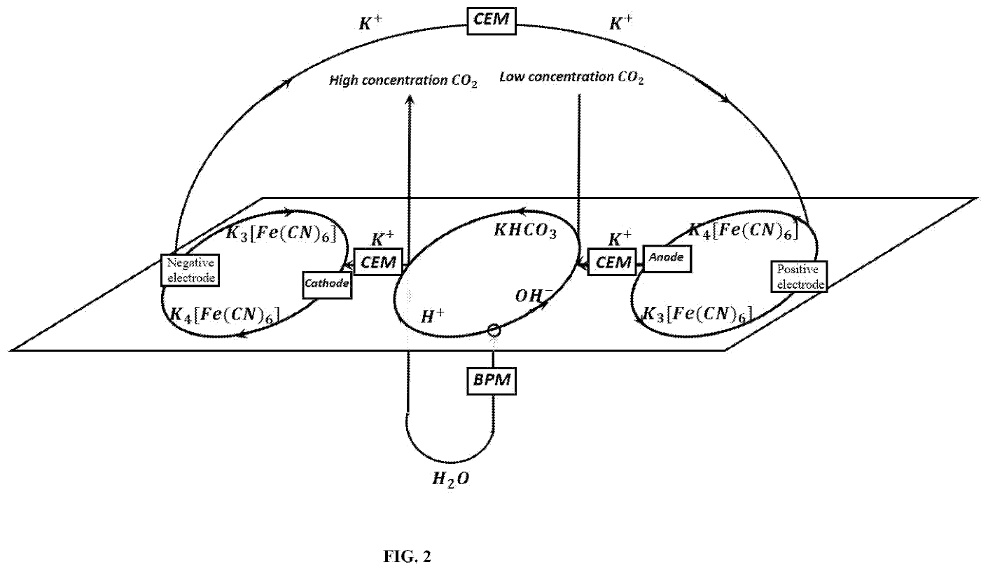

The device based on an electrically-driven chemical carbon pump combined cycle for a diluted carbon source in the present disclosure, as shown in FIG. 2, is essentially a combination of an inner cycle and an outer cycle. This cycle realized the transformation from electrical energy to chemical work through a combined cycle consisting of reactions involving multiple electrolytes, so as to directly capture CO₂ from the diluted carbon source.

The combined cycle included an inner cycle and an outer cycle. The process of inner cycle was as follows: the diluted carbon source was introduced. Low concentration CO₂ reacted and was absorbed by the absorption solution, and reacted again in the next step of the cycle. The CO₂ was precipitated out of the solution and was captured, and the remaining absorption solution was sent back to the previous step for further use. Specifically, the diluted carbon source was introduced into the KHCO₃ absorption solution in the CO₂ absorption chamber. CO₂ (low concentration CO₂) in the diluted carbon source reacted with OH⁻ from the BPM to generate HCO₃⁻, which combined with K⁺ from the anode (anode reaction chamber) to generate KHCO₃. The KHCO₃ solution was transferred to the CO₂ desorption chamber, and reacted with H⁺ from the BPM to generate CO₂ (high concentration CO₂), H₂O, and K⁺. K⁺ was transported to the cathode reaction chamber through the CEM, CO₂ (high concentration CO₂) was precipitated out of the solution and was captured, and the remaining low concentration KHCO₃ solution was sent back to the previous step of the cycle to continue to absorb CO₂ from the diluted carbon source. The inner cycle was mainly responsible for absorbing and capturing CO₂ from the diluted carbon source.

The outer cycle was mainly achieved through the interconversion between the fast kinetic redox pair solutions A and B. The process was as follows: after the reaction of the electrolyte located near the positive and negative electrodes, it was sent to the cathode (cathode reaction chamber) and the anode (anode reaction chamber), in which the reverse reaction occurred again. After the reaction, the electrolyte was sent back to the positive and negative electrodes to continue the above reaction, so as to complete the cycle. Specifically, A at the negative electrode was oxidized to B, and B was sent to the cathode for reaction to be reduced again to A. The resulting A was pumped to a liquid storage tank and sent back to the negative electrode to complete the next cycle. The B at the positive electrode was reduced to A, and A was sent to the anode for reaction to be oxidized again to B. The resulting B was pumped to another liquid storage tank and sent back to the positive electrode to complete the next cycle. The electrical energy released by the reaction of the positive and negative electrodes was provided to the anode and the cathode, so the outer cycle was mainly responsible for providing the electrical energy to drive the process of capturing CO₂ from the air. K₄[Fe(CN)₆] and K₃[Fe(CN)₆] could be selected as the solution A and the solution B respectively.

In the combined cycle, the process involving CO₂ was as follows: the diluted carbon source was introduced into the KHCO₃ absorption solution, in which the low concentration CO₂ reacted with OH⁻ from the BPM, and it mainly existed in the absorption solution in the form of HCO₃⁻. The absorption solution was then transferred to the other side of the BPM, and HCO₃ reacted with H⁺ from the BPM and was precipitated again in the form of CO₂. At this time, CO₂ had a relatively high purity, and could be reused after being captured.

The present disclosure relates to the following main reactions.

CO₂ absorption: OH⁻+CO₂ (aq)↔HCO₃⁻

CO₂ desorption: HCO₃⁻+H⁺↔CO₂ (aq)+H₂O

CO₂ (aq)→CO₂ (g)

Reaction in the BPM: H₂O↔H⁺+OH⁻

Anode reaction: A-e⁻→B

Cathode reaction: B+e⁻→A

Taking fast kinetic redox pair K₃/K₄[Fe(CN)₆] solution as an example, the anode and cathode reactions are as follows.

Anode reaction: [Fe(CN)₆]⁴⁻-e⁻→[Fe(CN)₆]³⁻

Cathode reaction: [Fe(CN)₆]³⁻+e⁻→[Fe(CN)₆]⁴⁻

Reactions in the positive and negative electrodes of the outer cycle are as follows.

$$Positive electrode {: [ {Fe ( CN )}_{6} ]}^{3 -} + {e}^{-} {⟶}^{Discharge} {[ {Fe ( CN )}_{6} ]}^{4 -} \\ Negative electrode {: [ {Fe ( CN )}_{6} ]}^{4 -} - {e}^{-} {⟶}^{Discharge} {[ {Fe ( CN )}_{6} ]}^{3 -}$$

The present disclosure further provided a specific method using the device based on an electrically-driven chemical carbon pump combined cycle for a diluted carbon source. Under the system temperature of 20° C. and the ambient pressure of 1 standard atmospheric pressure, the electrolytic cell was divided into four chambers by the BPM and two CEMs. The cathode reaction chamber and the anode reaction chamber were connected with the negative and positive electrodes of the cell structure through two electrodes. Then, a KHCO₃ solution was introduced into the CO₂ absorption chamber and the CO₂ desorption chamber separated by the BPM. A K₄[Fe(CN)₆] solution was introduced into the anode reaction chamber. A K₃[Fe(CN)₆] solution was introduced into the cathode reaction chamber. In the outer cycle, the positive and negative electrodes of the cell structure were distributed on both sides, and the electrolyte region was between the two electrodes. A CEM was used in the middle of the electrolyte region to divide the region into two parts. A K₃[Fe(CN)₆] solution was introduced into the positive region and a K₄[Fe(CN)₆] solution was introduced into the negative region.

In the inner cycle, air was introduced into the CO₂ absorption chamber, and the circuit was switched on. CO₂ reacted with OH⁻ from the BPM to generate HCO₃⁻, so as to achieve charge balance with K⁺ from the anode reaction chamber. The KHCO₃ solution was introduced into the CO₂ desorption chamber through an external channel, and reacted with H⁺ from the BPM to generate CO₂, H₂O and K⁺. K⁺ was transported to the cathode reaction chamber through the CEM, and CO₂ was precipitated out of the solution and captured at the outlet of the device. The KHCO₃ solution recovered to its initial concentration in the CO₂ absorption chamber and was sent back to the CO₂ absorption chamber through an external channel.

The fast kinetic redox pair K₃[Fe(CN)₆] and K₄[Fe(CN)₆] solutions were continuously circulated in the outer cycle composed of the liquid storage tank, the cell structure and two electrode reaction chambers, which ensured the stable operation of the system and eliminated the influence of concentration polarization overpotential. In addition, K⁺ moved from the anode to the cathode in the inner cycle and from the negative electrode to the positive electrode in the outer cycle, thus maintaining the ion balance in the whole system.

The device based on an electrically-driven chemical carbon pump combined cycle for a diluted carbon source provided by the example of the present disclosure could also be combined with the unmanned vehicle. In the charging mode, when the unmanned vehicle was on land, the cell structure was charged through the external power supply. At this time, K₄[Fe(CN)₆] in the anode region was oxidized to K₃[Fe(CN)₆], and K₃[Fe(CN)₆] in the cathode region was reduced to K₄[Fe(CN)₆]. In the mode of discharging to the unmanned vehicle, when the unmanned vehicle left the land for work, the cell structure started to discharge, and the auxiliary power supply for the unmanned vehicle was realized through the concentration difference change of the K₃/K₄[Fe(CN)₆] electrolyte. In the carbon capture mode, the unmanned vehicle left the land and started to work, and the cell structure in the outer cycle discharged to maintain the operation of the inner cycle, so as to achieve carbon capture.

1. The device based on an electrically-driven chemical carbon pump combined cycle for a diluted carbon source provided by the present disclosure is essentially a combination of an inner cycle and an outer cycle. This cycle realizes the transformation from electrical energy to chemical work through reactions involving multiple electrolytes, so as to directly capture CO₂ from the diluted carbon source, which provides an idea for carbon capture from the diluted carbon source.

2. The device based on an electrically-driven chemical carbon pump combined cycle for a diluted carbon source provided by the present disclosure can also be combined with the unmanned vehicle, which realizes distributed carbon capture.

3. The device based on an electrically-driven chemical carbon pump combined cycle for a diluted carbon source provided by the present disclosure realizes carbon capture using EDBM, which can improve a carbon capture rate and capture purity.

Each example of the present specification is described in a progressive manner, each example focuses on the difference from other examples, and the same and similar parts between the examples may refer to each other.

Specific examples are used herein to explain the principles and implementations of the present disclosure. The foregoing description of the examples is merely intended to help understand the method of the present disclosure and its core ideas; besides, various modifications may be made by those of ordinary skill in the art to specific implementations and the scope of application in accordance with the ideas of the present disclosure. In conclusion, the content of the present specification shall not be construed as limitations to the present disclosure.

1. A device based on an electrically-driven chemical carbon pump combined cycle for a diluted carbon source, comprising:
an electrolytic cell and a cell structure, wherein the electrolytic cell comprises a cathode reaction chamber, a CO₂ desorption chamber, a CO₂ absorption chamber, and an anode reaction chamber that are connected in sequence; and the CO₂ desorption chamber and the CO₂ absorption chamber are communicated through a bipolar membrane (BPM);
the cell structure comprises: a negative electrode, a positive electrode, a positive region, and a negative region; and the negative electrode is arranged in the negative region, and the positive electrode is arranged in the positive region; and
the negative electrode is connected with the cathode reaction chamber; the positive electrode is connected with the anode reaction chamber, and a liquid outlet of the negative region is communicated with a liquid inlet of the cathode reaction chamber; a liquid inlet of the negative region is communicated with a liquid outlet of the cathode reaction chamber; a liquid outlet of the positive region is communicated with a liquid inlet of the anode reaction chamber; and a liquid inlet of the positive region is communicated with a liquid outlet of the anode reaction chamber.

2. The device based on an electrically-driven chemical carbon pump combined cycle for a diluted carbon source according to claim 1, wherein a K₄[Fe(CN)₆] solution is introduced into the negative region and a K₃[Fe(CN)₆] solution is introduced into the positive region.

3. The device based on an electrically-driven chemical carbon pump combined cycle for a diluted carbon source according to claim 1, further comprising: a K₄[Fe(CN)₆] solution storage tank, wherein a liquid inlet of the K₄[Fe(CN)₆] solution storage tank is communicated with a liquid outlet of the cathode reaction chamber, and a liquid outlet of the K₄[Fe(CN)₆] solution storage tank is communicated with a liquid inlet of the negative region.

4. The device based on an electrically-driven chemical carbon pump combined cycle for a diluted carbon source according to claim 1, further comprising: a K₃[Fe(CN)₆] solution storage tank, wherein a liquid inlet of the K₃[Fe(CN)₆] solution storage tank is communicated with a liquid outlet of the anode reaction chamber, and a liquid outlet of the K₃[Fe(CN)₆] solution storage tank is communicated with a liquid inlet of the positive region.

5. The device based on an electrically-driven chemical carbon pump combined cycle for a diluted carbon source according to claim 1, wherein the cathode reaction chamber is communicated with the CO₂ desorption chamber through a cation exchange membrane (CEM), and the CO₂ absorption chamber is communicated with the anode reaction chamber through a CEM.

6. The device based on an electrically-driven chemical carbon pump combined cycle for a diluted carbon source according to claim 1, wherein the positive region is communicated with the negative region through a CEM.

7. The device based on an electrically-driven chemical carbon pump combined cycle for a diluted carbon source according to claim 1, wherein a solution in the CO₂ desorption chamber and the CO₂ absorption chamber is a KHCO₃ solution.

8. A method based on an electrically-driven chemical carbon pump combined cycle for a diluted carbon source, applied to the device based on an electrically-driven chemical carbon pump combined cycle for a diluted carbon source according to claim 1, and comprising:
introducing a diluted carbon source containing CO₂ of a first concentration into the CO₂ absorption chamber, wherein the CO₂ of the first concentration reacts with OH from the BPM in the CO₂ absorption chamber to generate HCO₃⁻;
enabling the HCO₃⁻ to combine with K⁺ from the anode reaction chamber to generate a KHCO₃ solution; and
introducing the generated KHCO₃ solution into the CO₂ desorption chamber, wherein the generated KHCO₃ reacts with H⁺ from the BPM in the CO₂ desorption chamber to generate H₂O, K⁺, and CO₂ of a second concentration; and precipitating the CO₂ of the second concentration and capturing the CO₂ of the second concentration at an air outlet of the CO₂ desorption chamber, wherein the second concentration is greater than the first concentration.

9. The method according to claim 8, wherein a K₄[Fe(CN)₆] solution is introduced into the negative region and a K₃[Fe(CN)₆] solution is introduced into the positive region.

10. The method according to claim 8, further comprising: a K₄[Fe(CN)₆] solution storage tank, wherein a liquid inlet of the K₄[Fe(CN)₆] solution storage tank is communicated with a liquid outlet of the cathode reaction chamber, and a liquid outlet of the K₄[Fe(CN)₆] solution storage tank is communicated with a liquid inlet of the negative region.

11. The method according to claim 8, further comprising: a K₃[Fe(CN)₆] solution storage tank, wherein a liquid inlet of the K₃[Fe(CN)₆] solution storage tank is communicated with a liquid outlet of the anode reaction chamber, and a liquid outlet of the K₃[Fe(CN)₆] solution storage tank is communicated with a liquid inlet of the positive region.

12. The method according to claim 8, wherein the cathode reaction chamber is communicated with the CO₂ desorption chamber through a cation exchange membrane (CEM), and the CO₂ absorption chamber is communicated with the anode reaction chamber through a CEM.

13. The method according to claim 8, wherein the positive region is communicated with the negative region through a CEM.

14. The method according to claim 8, wherein a solution in the CO₂ desorption chamber and the CO₂ absorption chamber is a KHCO₃ solution.
